(19) United States
(12) Patent Application Publication
(10) Pub. No.: US 2023/0211988 A1
(43) Pub. Date: Jul. 6, 2023

(54) RADAR-ABSORBING HANDLING DEVICE

(71) Applicant: ZF Friedrichshafen AG, Friedrichshafen (DE)

(72) Inventors: Gabriela Jager, Friedrichshafen (DE); Stefan Traub, Friedrichshafen (DE)

(73) Assignee: ZF Friedrichshafen AG, Friedrichshafen (DE)

(21) Appl. No.: 17/997,436

(22) PCT Filed: Mar. 16, 2021
(86) PCT No.: PCT/EP2021/056584

§ 371 Date: Oct. 28, 2022

(30) Foreign Application Priority Data
Aug. 7, 2020 (DE) 10 2020 210 020.9

(51) Int. Cl. B66F 9/075; B66F 9/18; G01S 13/88; G01S 7/41; G01S 13/42; B66C 13/46

(52) U.S. Cl. CPC B66F 9/0755; B66F 9/186; G01S 13/88; G01S 7/411; G01S 13/42; B66C 13/46; B66C 23/64

(57) ABSTRACT

A handling device (103) for loads (105) includes a radar transmitter (107), a radar sensor (111) and a data-processing device. The radar transmitter (107) is configured to irradiate at least part of the handling device (103) and/or the load (105). The radar sensor (111) is configured to detect at least part of the irradiated handling device (103) and/or the irradiated load (105). The data-processing device is configured to determine the position of at least part of the handling device (103) and/or the load 105) with reference to a signal from the radar sensor (111). At least a part (405) of the handling device (103) is radar-absorbing.

### RELATED APPLICATIONS

This application claims the benefit under 35 U.S.C. § 371 as a U.S. National Application of application no. PCT/EP2021/056584, filed on 16 Mar. 2021, which claims benefit of German Patent Application no. 10 2020 210 020.9 filed 7 Aug. 2020, the contents of which are hereby incorporated herein by reference in their entireties.

### FIELD OF THE DISCLOSURE

The present disclosure relates generally to handling devices for a load, and more particularly to a radar-absorbing handling device.

### BACKGROUND

From the prior art it is known to determine the position of the boom of a crane by means of radar measurements. The position of the suspended load can be determined in the same way. In that way, in every radar image there are measurement points both of the boom and also of the load. For further processing the measurement points of the boom and those of the load have to be separated from one another. Known algorithms for that purpose are complicated and prone to error.

The document DE 10 2017 005 920 A1 discloses a device for calibrating an environment sensor. For this, a calibration body and a reflector are attached to a pendulum rod with a pendulum mass. The pendulum rod hangs on a frame. This is radar-absorbing.

### SUMMARY

The purpose of the present invention is to improve the radar-based determination of the position of at least part of a handling device and/or a load. This objective is achieved by an arrangement according to claim 1. Preferred further developments are described in the subordinate claims and emerge from the description given below and from the example embodiments illustrated n the figures.

The arrangement comprises a handling device for a load, a radar transmitter, a radar sensor and a data-processing device.

The handling device is understood to be a device for moving the load. Moving the load can in particular include lifting the load and putting it down again in another location. To move the load, the handling device preferably comprises a fixing device. The fixing device serves for fixing the load. In addition, the handling device preferably comprises a device for moving the fixing device. In particular, the fixing device can be moved with the load fixed in the fixing device.

The handling device is preferably part of a vehicle, such as a crane, a bagger, or a fork-lift. Correspondingly, the handling device can be a crane boom, a bagger arm, or a lifting frame.

Besides the handling device, the radar transmitter, the radar sensor, and/or the data-processing device can also be part of the vehicle. Alternatively, the data-processing device in particular can be made separately from the vehicle. In that case the vehicle is connected for data exchange with the data-processing device, preferably by means of remote data transmission.

The load preferably consists of piece goods such as a package or a loaded pallet.

The radar transmitter is a means for sending out radar beams. Thus, the radar transmitter is designed to send out electromagnetic waves in a range from 30 MHz to 300 GHz. Preferably, the waves from the radar transmitter are sent out in bundled form.

The radar sensor is a means for receiving a radar beam. It is designed to receive the radar beam sent out by the radar transmitter, at least partially. Preferably, a frequency range of the radiation that can be received by the radar sensor matches the frequency range of the radiation sent out by the radar transmitter.

The radar transmitter is designed to irradiate at least part of the handling device. The said at least part of the handing device is irradiated with radar radiation by the radar transmitter. Thus, the radar transmitter and the handling device are orientated relative to one another in such manner that the handling device is located at least partially in an area irradiated by the radar transmitter.

The radar sensor detects at least part of the handling device and/or the load. This means that the radar transmitter is designed to detect, at least partially, radar radiation reflected from the handling device and/or the load. To do this, the radar sensor must be positioned and orientated suitably relative to the handling device. In detail, the radar sensor must be positioned and orientated in such manner that at least part of the handling device and/or the load is located within a detection field.

The data-processing device is designed to determine the position of at least part of the handling device and/or the load. With reference to the signal from the radar sensor, the data-processing device determines the position of the said at least part of the handling device and/or the load, preferably relative to a reference system fixed in relation to the sensor. In particular, this can be a reference system fixed on the vehicle.

In the present context ‘position determination’ includes determining the location and/or the position of an object.

According to the invention, at least part of the handling device is radar-absorbing. This at least part of the handling device absorbs the radar radiation sent out by the radar transmitter. The said at least part can possibly be provided with a radar-absorbing coating or it can be made from a radar-absorbing material.

By virtue of the radar-absorbing part of the handling device, the signal of the radar sensor acquires distinctness. Thus, the radar-absorbing part of the handling device can be distinguished straightforwardly from the surrounding, from radar-reflecting parts, and/or from the load.

If at least part of the surface of the load is radar-reflecting, i.e. if at least part of the load consists of a radar-reflecting material, the position of the load can be determined in a simple way with the help of the invention. Since the radar-absorbing at least part of the handling device is not contained in the signal of the radar sensor, the evaluation and further processing can be limited to the data contained in the signal. A separation of the data into data due to a reflection from the handling device and data from a reflection of the load is not necessary.

In a preferred further development, a first part of the handling device is radar-reflecting. The surface of the said first part is thus such that it at least partially reflects the radar radiation sent out by the radar transmitter when it strikes the said surface.

A second part of the handling device is further developed to be radar-absorbing. This part absorbs the radar radiation sent out by the radar transmitter when it strikes the surface.

The second part, or its surface, is at least partially, and preferably completely surrounded by the first part, or its surface.

The data-processing device is further developed so as to determine the position of the second part. This can be done advantageously, since the second part can be determined indirectly. The second part appears as a “hole” within the reflection of the first part in the signal received by the radar sensor. The determination of the position of the second part is therefore limited to the determination of the position of the said “hole.”

In an alternative preferred further development, all the parts of the handling device that can be brought within the detection field of the radar sensor are radar-absorbent. In particular, parts of the handling device can be brought into the detection field by moving the handling device. A handling device designed to be completely radar-absorbing is advantageous from the standpoint of determining the position of the load, since no reflections from the handling device interfere with the position determination.

Preferably, the handling device is developed further as a crane boom. The crane boom comprises a cable with a hook or an eyelet for attaching the load. The radar sensor is positioned and orientated in such manner that it detects the load attached to the hook or eyelet.

According to a further development, at least two signals of the radar sensor offset in time relative to one another are passed on to the data-processing device. The latter is designed to merge the signals. In detail, this means that from the reflections of the load contained in the signals the data-processing device creates a completed image of the load. This is based on the recognition that on the way to the radar sensor the reflections are shaded by the crane boom. Thus, a part of the load shaded by the crane boom is missing from the reflections detected by the radar sensor. However, it is to be expected that the load is swinging. This has the result that in the two signals, in each case another part is shaded by the crane boom. By virtue of the merging, the shaded parts can be reconstructed so that the data-processing device contains a complete image of the load.

### BRIEF DESCRIPTION OF THE DRAWINGS

Preferred example embodiments of the invention are illustrated in the figures, in which matching indexes denote the same or functionally equivalent features. In detail, the figures show:

FIG. 1: A fork-lift with a crane attachment; and

FIG. 2: The same fork-lift with a radar-absorbing crane attachment;

FIG. 3: The merging of radar data; and

FIG. 4: A radar-absorbing coated hydraulic cylinder.

### DETAILED DESCRIPTION

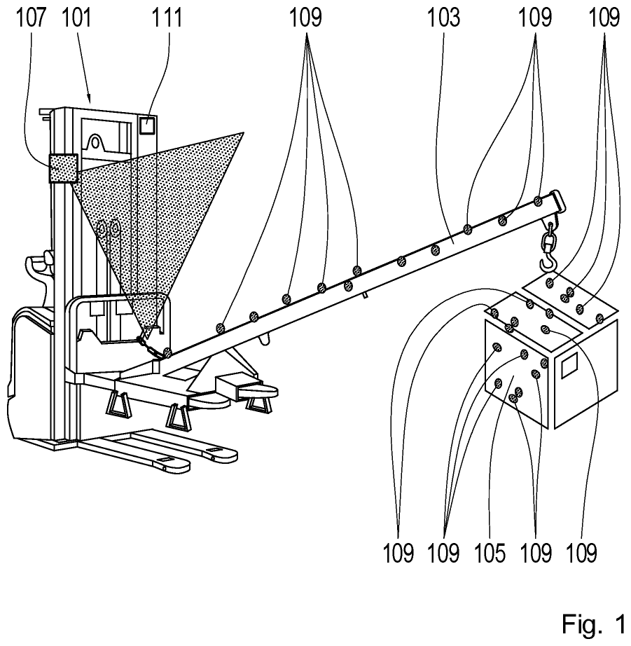

The fork-lift 101 shown in FIG. 1 is equipped with a crane boom 103. A package 105 hangs from the crane boom 103.

A lifting mast 101 of the fork-lift has a radar transmitter 107. This is orientated in such manner that it irradiates the package 105. Corresponding reflections 109 are detected by a radar sensor 111 also fixed on the lifting mast.

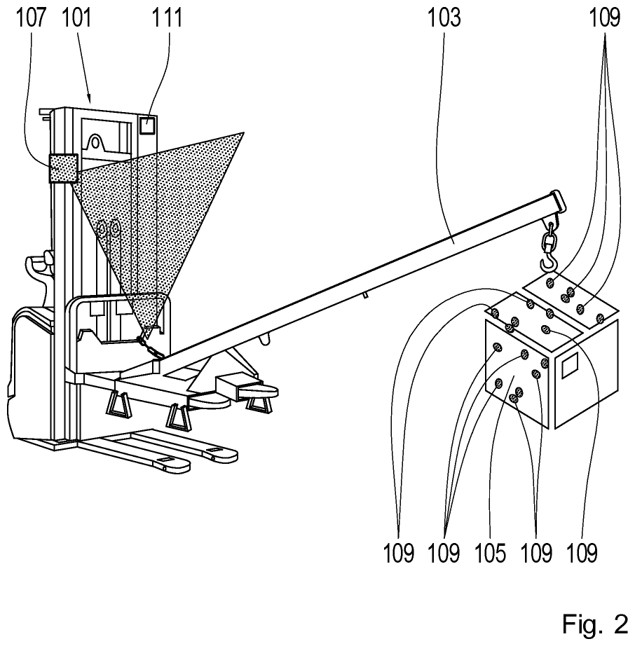

Since not only the package 105 but also the crane boom 103 is irradiated by the radar transmitter 107 and they are within the detection field of the radar sensor 111, besides the reflections 109 from the package 105 the radar sensor 111 also detects reflections 109 from the crane boom 103. As shown in FIG. 2, this can be prevented by a radar-absorbing coating of the crane boom 103.

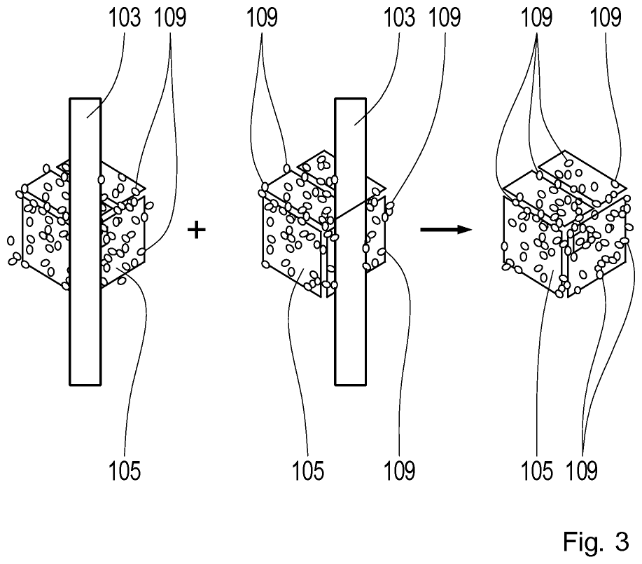

FIG. 3 illustrates how the package 105 is shaded by the crane boom 103. However, since the package 105 is swinging the shading is not static. Thus, depending on the detection point in time, different areas of the package 105 are shaded. Consequently, from individual images obtained by the radar sensor 111 at different points in time, a complete, unshaded image of the package 105 can be generated. This is shown in FIG. 3 on the right.

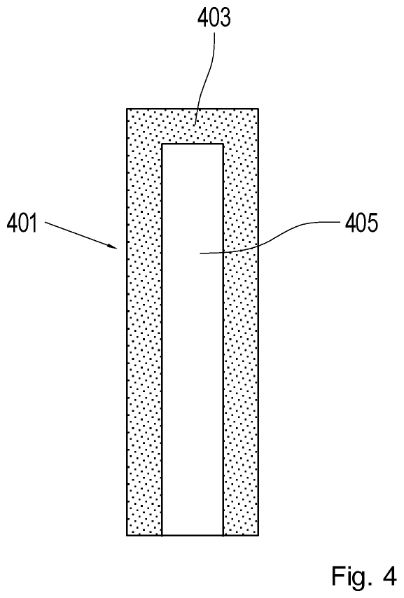

FIG. 4 shows a hydraulic cylinder 401 of a lifting frame of a wheel loader. The surface of the hydraulic cylinder 401 is divided into a first area 403 and a second area 405. The first area 403 reflects radar radiation. The second area 405 is provided with a radar-absorbing coating. Consequently, the second area 405 can be identified very simply in an image of a radar sensor. With reference to the shape and position of the second area 405 in the image, conclusions can be drawn about the location and position of the hydraulic cylinder 401.

### INDEXES

101 Fork-lift

103 Crane boom

105 Package

107 Radar transmitter

109 Reflection

111 Radar sensor

401 Hydraulic cylinder

403 First area

405 Second area

1. A handling device (103) for handling a load (105), the handling device comprising:
a radar transmitter (107);
a radar sensor (111); and
a data-processing device;
wherein the radar transmitter (107) is configured to irradiate at least part of the handling device (103) and/or the load (105) handled by the handling device;
wherein the radar sensor (111) is configured to detect at least part of the handling device (103) and/or the load (105) as a result of being irradiated; and
wherein the data-processing device is configured to determine the position of at least part of the handling device (103) and/or the load (105) with reference to a signal from the radar sensor (111); and
wherein at least a part (405) of the handling device (103) is radar-absorbing.

2. The handling device according to claim 1, wherein a first part (403) of the handling device (103) is radar-reflecting; and a second part (405) of the handling device (103) is radar-absorbing; wherein the said second part (405) is at least partially surrounded by the first part (403); and wherein the data-processing device is configured to determine the position of the second part (405).

3. The handling device according to claim 1, wherein all parts of the handling device (103) which can be brought within a detection field of the radar sensor (111) are radar-absorbing.

4. The handling device according to claim 1,
as wherein the handling device (103) is configured as a crane boom;
wherein the radar sensor (111) is configured to detect the load (105); and
wherein the data-processing device is designed to merge signals from the radar sensor (111) which have been detected with a time offset relative to one another.

5. The handling device according to claim 2,
wherein the handling device (103) is configured as a crane boom;
wherein the radar sensor (111) is configured to detect the load (105); and
wherein the data-processing device is designed to merge signals from the radar sensor (111) which have been detected with a time offset relative to one another.

6. The handling device according to claim 3,
wherein the handling device (103) is configured as a crane boom;
wherein the radar sensor (111) is configured to detect the load (105); and
wherein the data-processing device is designed to merge signals from the radar sensor (111) which have been detected with a time offset relative to one another.
